(19) United States
(12) Patent Application Publication
(10) Pub. No.: US 2019/0334758 A1
(43) Pub. Date: Oct. 31, 2019

(54) COMPLIANCE MANAGEMENT AND VISUALIZATION OF NODES IN A NETWORK

(71) Applicant: Uppmarket, Inc., Troy, NY (US)

(72) Inventor: Howard Diamond, Troy, NY (US)

(21) Appl. No.: 16/397,151

(22) Filed: Apr. 29, 2019

Related U.S. Application Data
(60) Provisional application No. 62/664,431, filed on Apr. 30, 2018.

(51) Int. Cl. H04L 12/24; H04L 29/06; H04L 29/08

(52) U.S. Cl. CPC H04L 41/046; H04L 63/08; H04L 41/0893; H04L 41/22; H04L 67/2809

(57) ABSTRACT

A system, method and program product for implementing a technology platform for managing and visualizing compliance of nodes in a hierarchical network. A disclosed platform includes: a system for interfacing with the network, wherein the network includes an enterprise node that provisions a proprietary resource to a set of broker nodes and a set of provider nodes; a monitoring system that deploys agents to crawl the network to identify and analyze provider nodes that offer the proprietary resource to determine a compliance of each provider node in accordance with a policy; a registration system for authorizing provider nodes within the network; an enterprise database that stores compliance data and authorization data for provider nodes in the network; and a visualization system for visualizing compliance data regarding the provider nodes.

### TECHNICAL FIELD

The subject matter of this invention relates to managing nodes in a network and more particularly to a system and method of managing and visualizing compliance of nodes in a hierarchical network.

### BACKGROUND

Hierarchical networks exist in any number of fields in which information, agents, programs, products, services etc., (i.e., resources) flow from high level nodes to lower level nodes. Oftentimes, lower level nodes (e.g., grandchildren) become operationally separated from higher level nodes (e.g., grandparents) such that the higher level nodes lose control over or lack knowledge of the lower level nodes despite having compliance policies and rules in place.

For example, in an Internet-of-Things (IoT) environment, an enterprise node may provision artificial intelligence based software agents (“smart agents”) to a set of broker nodes, who in turn supply the smart agents to provider nodes that vend the smart agents to end user devices, such as autonomous vehicles, smart appliances, etc. The enterprise node may for example be in competition with other providers, and may thus need to maintain control over and protect the proprietary nature of its resources. One mechanism for ensuring such compliance is to provision resources according to defined policies. However, in a disjointed environment where resources are passed among nodes in a network that operate substantially independently of each other, challenges arise when trying to ensuring compliance among nodes.

### SUMMARY

Aspects of the disclosure provide a technology platform for managing and visualizing compliance of nodes in a hierarchical network.

One aspect discloses a platform for managing and visualizing compliance of nodes in a hierarchical network (“network”), comprising: a system for interfacing with the network, wherein the network includes an enterprise node that provisions a proprietary resource to a set of broker nodes and a set of provider nodes; a monitoring system that deploys agents to crawl the network to identify and analyze provider nodes that offer the proprietary resource to determine a compliance of each provider node in accordance with a policy; a registration system for authorizing provider nodes within the network; an enterprise database that stores compliance data and authorization data for provider nodes in the network; and a visualization system for visualizing compliance data regarding the provider nodes.

Another aspect provides a computer program product stored on a non-transitory computer medium, which when executed by a computing systems, provides a platform for managing and visualizing compliance of nodes in a network, the program product comprising: program code for interfacing with the network, wherein the network includes an enterprise node that provisions a proprietary resource to a set of broker nodes and a set of provider nodes; program code that deploys agents to crawl the network to identify and analyze provider nodes that offer the proprietary resource to determine a compliance of each provider node in accordance with a policy; program code for authorizing provider nodes within the network; program code that stores compliance data and authorization data for provider nodes in the network; and program code for visualizing compliance data regarding the provider nodes.

Another aspect provides a computerized method for managing and visualizing compliance of nodes in a network, the method comprising: providing an interfacing with the network, wherein the network includes an enterprise node that provisions a proprietary resource to a set of broker nodes and a set of provider nodes; deploying agents to crawl the network to identify and analyze provider nodes that offer the proprietary resource to determine a compliance of each provider node in accordance with a policy; authorizing provider nodes within the network; storing compliance data and authorization data for provider nodes in the network; and visualizing compliance data regarding the provider nodes.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a hierarchical network of nodes according to embodiments.

FIG. 2 shows a computing system having a compliance and visualization platform according to embodiments.

FIG. 3 depicts a monitoring system interface according to embodiments.

FIG. 4 depicts a visualization dashboard according to embodiments.

FIG. 5 depicts a flow diagram showing a process for monitoring and analyzing nodes in a network.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

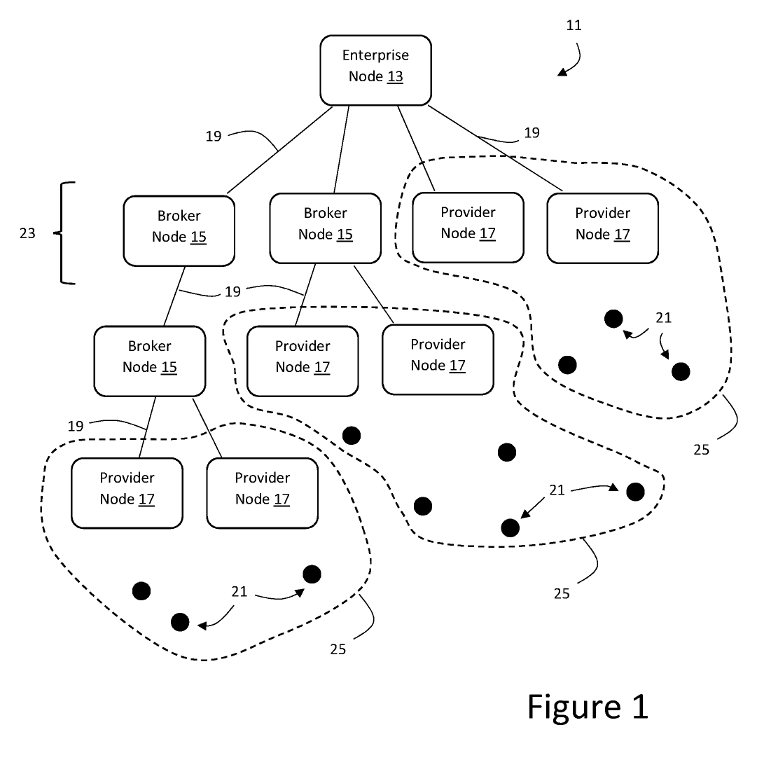

Referring now to the drawings, FIG. 1 depicts a hierarchical network 11 that generically represents any type of network that utilizes a computerized infrastructure to facilitate the flow of resources through a set nodes. Embodiments of this disclosure provide a technical solution for visualizing and managing compliance of nodes associated with the provisioning of proprietary resources. In this example, an enterprise node 13 is at the top of the network 11, which in turn interfaces with one or more broker nodes 15, which in turn interface with provider nodes 17 or other broker nodes 15. The enterprise node 13 may for example comprise any entity (a computer, a server, a cloud service, a virtual environment, a physical environment, etc.) that provisions proprietary resources (e.g., data, media content, software, hardware, services, goods, etc.). Each broker node 15 may for example comprise any platform (e.g., a CRM system, an ERP system, software, a device such as an FPGA, a cloud service, a distribution platform, etc.) that for example provides a middleware function, distributes, resells, etc., proprietary resources of the enterprise node 13 to one or more provider nodes 17.

Provider nodes 17 may for example comprise clients, servers, websites, a cloud service, etc. Provider nodes 17 in turn make the proprietary resources of the enterprise node available to consumer nodes 21 (e.g., via clients, browsers, websites, servers, App stores, etc.). As shown, the provider nodes 17 and consumer nodes may reside in distinct distribution channels 25. Depending on the implementation, channels 25 may represent different cloud services (Amazon Web Service, Google Cloud Platform, etc.), different IoT platforms (Azure, SAP, Cisco, etc.) different geographies (Europe, North America, etc.), different service providers (Verizon, AT&T, etc.), different online platforms (Ebay, Amazon, etc.), different gaming system (Xbox, PlayStation, etc.), etc.

The arrangement thus allows enterprise nodes 13 to provision proprietary resources indirectly to a large set of consumer nodes 21 via the hierarchical network 11, which may for example be deployed via the Internet, World Wide Web, a proprietary network, etc. In the hierarchical network 11, nodes are connected via edges that include policies 19 (i.e., agreements, rules, etc.) the participating nodes are expected to follow when engaging in transactions associated with the proprietary resources. For example, a policy may dictate transaction parameters (e.g., timing, volume, costs, etc.), restrictions (e.g., a list of provider nodes 15 a broker node 15 can/cannot transact with), etc.

For example, consider an enterprise node 13 that provides data security software utilities such as anti-virus algorithms, encryption systems, anti-hacking systems, etc., to protect aspect of the network 11. Assume that the utilities are branded and include source code that can be automatically configured by the broker nodes 15 or provider nodes 17 to customize utilities for different end users 21 or channels 25. Further, assume that policies set by the enterprise node 13 require how the branding must be used, what types of modifications are allowed to the source code, and what the cost structure should be. If provider nodes 17 are not in direct contact with the enterprise node 13, it can be a challenge to ensure that the utilities are being provisioned in an authorized manner. Failures of the broker nodes 15 and provider nodes 17 to adhere to such policies can result in technical malfunctions, poor network performance, loss of revenue, loss of goodwill, etc.

Accordingly, provisioning resources throughout hierarchical networks 11 and the like entail numerous technical challenges for an enterprise node 13. Firstly, the number of provider nodes 17 in a particular environment may be in the hundreds or thousands, and the number of different resources being provisioned via the network 11 may be in hundreds or thousands, or more. Secondly, the hierarchical network 11 may be open and dynamic, with provider nodes 17 continuously joining and leaving the network 11 at their own discretion. Thirdly, the enterprise node 13 may only have direct control and/or relationships with nodes in a child level 23 just below the enterprise node 13. Fourthly, broker nodes 15 may be tasked with deploying policies 19 promulgated to them from the enterprise node 13 or other broker nodes, which can be easily misapplied, ignored, etc. In light of these technical challenges, the present invention provides a technical solution for managing compliance of nodes tasked with provisioning proprietary resources in a hierarchical network 11.

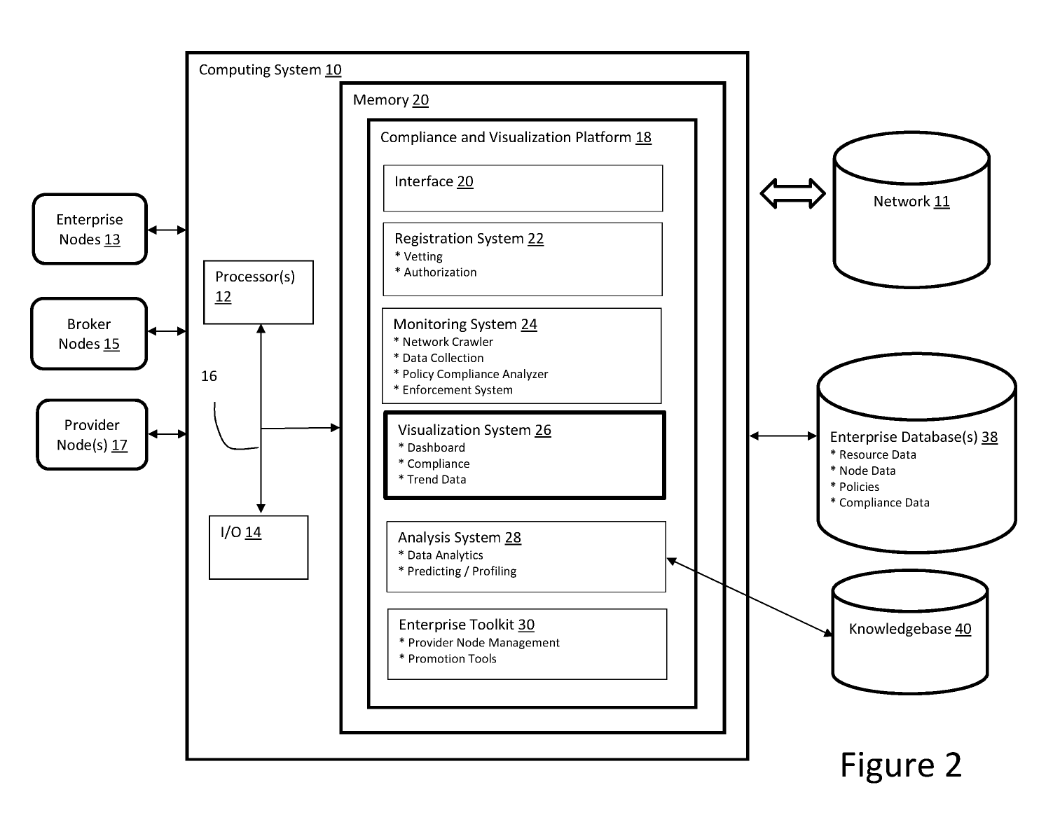

FIG. 2 depicts a computing system 10 having a compliance and visualization platform 18 for allowing an enterprise node 13 to manage and visualize compliance of provider nodes 17 and broker nodes 15 in a hierarchical network 11. Platform 18 generally includes an interface 20 that provides access for enterprise node(s) 13, e.g., directly or via an API, to manage provider nodes 17 (and broker nodes 15) offering and provisioning proprietary resources of the enterprise node(s) 13. Interface 20 allows an enterprise node 13 to load and access information in an enterprise database 38, including, e.g., data about the different proprietary resources provisioned by the enterprise node 13, information about existing broker nodes 15 and provider nodes 17, and policy requirements associated with different resources. For example, assume enterprise node 13 provides encrypted video content that can only be viewed by consumer nodes 21 having specialized hardware. In this case, the resource data may comprise different video titles, node data may include a list of known authorized providers, and policies might include the type of encryption to be used, watermarks required, cost parameters, etc.

One mechanism for ensuring compliance of nodes in the network 11 is to first authorize nodes via a registration system 22. The registration process may for example include a vetting process, e.g., does the node have the required technical capabilities, has the node engaged in previous unauthorized activities, etc. Once authorized, the provider node 17 can be documented in the enterprise database 38 as such. As noted however, because the network 11 may be open and dynamic in nature, provider nodes 17 may join and leave the network on a continual basis. Accordingly, it will be a technical challenge to authorize all nodes at any given time.

To address this, a monitoring system 24 is provided that, e.g., utilizes a network crawler or agent, to crawl network 11 to search for provider nodes 17 (and broker nodes 15) offering proprietary resources on the network 11. The monitoring system 24 may be configurable by the enterprise node 13 to target different resources and/or predetermined channels 25 at different times or frequencies. Selecting which proprietary resources or channels to monitor may for example be done as requested by the enterprise, according to a predefined schedule, as determined by an artificial intelligence (AI) agent, etc.

Other features of monitoring system 24 may include a policy compliance analyzer that determines if a given provider node 17 is in compliance with the required policies of the enterprise node 13. Compliance may be determined in any manner. The policy compliance analyzer may include an interface (e.g., drop down boxes, natural language, file upload, etc.) that allows an enterprise administrator (or other system) to establish a set of compliance parameters. For example, in the case of the security utilities example noted above, three compliance parameters may be set, including: (1) the type of branding required (e.g., logos, etc.), (2) the types of modifications allowed to the source code; and (3) the cost structure. These parameters may be collected and maintained in any manner, e.g., using computational logics, machine learning, traditional storage structures such as xml files, etc. Once established, policy compliance analyzer may compare the compliance parameters with data collected from nodes by the network crawler. For example, a provider node 17 offering a proprietary resource may comprise a website with HTML and JavaScript that can be scraped and analyzed to identify image elements (i.e., logos), operational behaviors (i.e., source code modifications), and cost parameters. Based on the analysis, a compliance may be calculated. Compliance may e.g., comprise a score, a set of values, an indicator (red, yellow, green), etc. Compliance data for analyzed nodes can be stored in the enterprise database 38.

In cases where a provider node 17 in not in compliance, an enforcement system may be deployed that, e.g., tries to shut down unauthorized provider nodes 17 or demand such provider nodes 17 become authorized by the enterprise node 13. Namely, when an unauthorized provider node 17 is located, or when a provider node 17 acting out of compliance is located, the monitoring system 24 may take automated actions to try to bring the provider node 17 into compliance, and “authorize” the provider node 17. As a simple example, an automated communication may be generated and sent (e.g., a cease and desist) demanding that the node stop offering a proprietary resource. In other examples, illicit behaviors may be reported to an ISP or other governing entity. In addition to policing unauthorized nodes, monitoring system 24 can also collect data regarding unauthorized activities, e.g., number and frequency of unauthorized activities, deviation from the policy, etc.

When an unauthorized provider node 17 is identified that wants to continue to provision proprietary resources of the enterprise node 13, registration system 22 provides an interface for onboarding new provider nodes 17, which may include automated vetting (e.g., prior performance, reference checking, credit checking, etc.) to authorize the provider node 17.

In order to optimize efforts involved in ensuring compliance within the network 11, visualization system 26 is provided to allow an enterprise administrator to examine the network 11 on a macro and granular level to better understand compliance among provider nodes 17. In particular, visualization system 26 pulls information collected and stored in the enterprise database 38 to depict and report on compliance of provider nodes 32. In one embodiment, a dashboard is utilized to visually display information from hundreds or thousands of provider nodes 17 into a concise easy to comprehend format. Using the dashboard, the enterprise node 13 is able to quickly ascertain the health of its proprietary resources being provisioned throughout the network 11, what level of compliance exists, what type of trends are occurring, etc.

It is understood that platform 18 may be utilized to manage compliance for many different enterprise nodes 13 using the network 11. The compliance information associated with each may be stored in a knowledgebase 40, which can be mined by analysis system 28. Analysis system 28 may for example use data analytics, AI, machine learning, etc., to predict, profile, etc., the efficacy of provider nodes 32, proprietary resources, seasonal behaviors, etc. For example, predictions can be made regarding the likely compliance rates for a given channel, proprietary resource, etc. This information can then be provided to enterprise nodes 13 or other entities to improve the operation of such hierarchical networks 11.

One mechanism for improving compliance includes an enterprise toolkit to help manage and enhance relationships with the provider nodes 17. For example, technical support, documentation, incentives, and promotional opportunities may be pushed to authorized provider nodes 17 to enhance offerings of proprietary resources.

It is understood that platform 18 may be utilized to manage and visualize compliance of any type of node hierarchy in which proprietary resources are being offered by a large number of provider nodes 17 to consumer nodes 21. Examples include, e.g., the distribution of smart agents in an IoT environment, the provisioning of computing resources in a cloud environment, channel networks for products, resources in a virtual or gaming universe, etc. As such, the platform 18 is intended as a unique technology solution with a wide range applications to which it may apply.

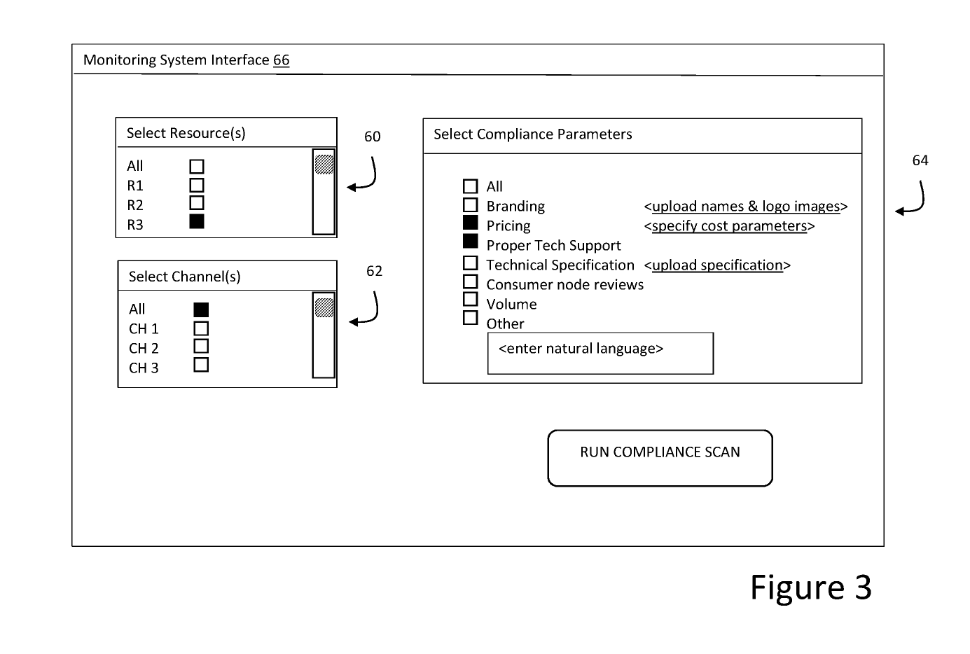

FIG. 3 depicts an illustrative monitoring system interface 66 that allows enterprise node administrators to run a compliance scan (i.e., launch crawlers and analyze nodes). In this example, the administrator selects one or more proprietary resources 60 (e.g., R3) and one or more channels 62 (e.g., All) that want to they want to evaluate. In addition one or more compliance parameters 64 are selected. Depending on the compliance parameter, additional information may need to be uploaded or specified, e.g., for branding the administrator can upload an image of a logo, for pricing the administrator might up load an MSRP, for technical specification, the administrator might upload source code, etc. In addition, the administrator can enter natural language using the “Other” selection, such as “the resource should not be offered on a same webpage with a competitor's resource”. Once the parameters are established, the compliance scan is run, and the network crawler identifies and analyzes nodes in the network 11. It is understood that the monitoring system interface 66 provides one possible example of how compliance parameters 64 can be specified to analyze nodes in a network 11, and is not intended to be limiting.

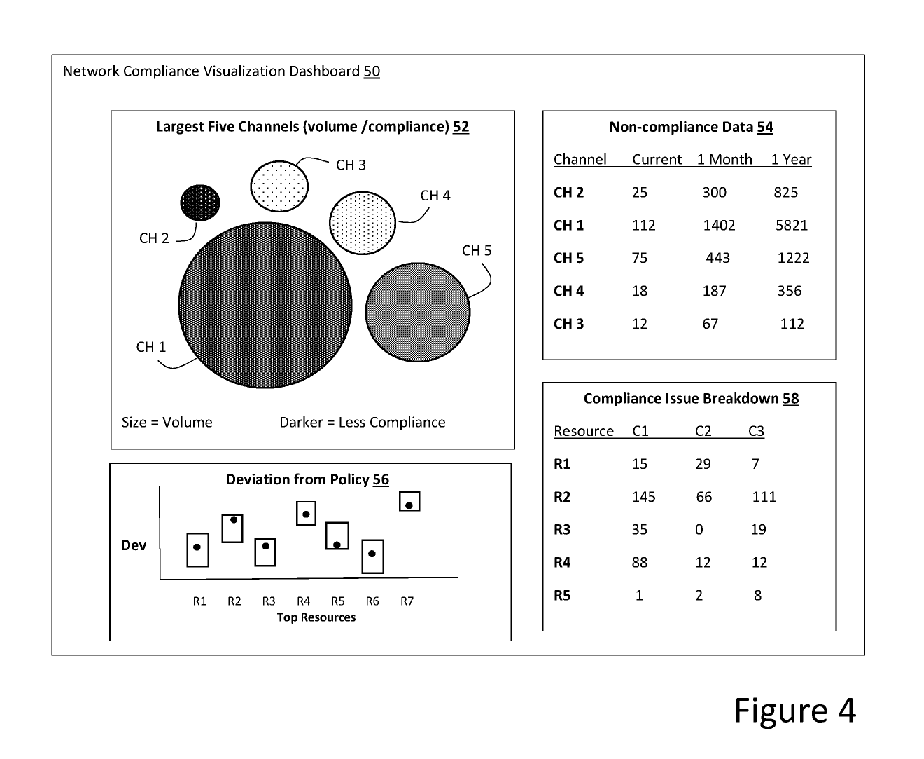

FIG. 4 depicts an illustrative network compliance visualization dashboard 50, in which various types of compliance data are shown. In the top left, a bubble chart shows the largest five channels 52, in which the size of bubble indicates the relative volume of resources being offered through each given channel (CH 1, CH 2, . . . CH 5). The color or shading of the bubble reflects the overall compliance of each channel, in which the darker the bubble, the worse the compliance. As can be seen, CH 2 has the smallest volume, but largest amount of compliance issues. CH 1 has the largest volume, and the second largest amount of compliance issues, etc. The chart on the top right provides non-compliance data 54 for each channel at the current time, as well as totals over the past month and year. By reviewing these charts, a user can quickly identify which channels have the largest compliance issues and require the most attention. In the chart on the upper right, it can be seen that CH 1 has the most compliance issues.

The lower left chart shows the top proprietary resources (R1, R2, . . . R7) being offered over the network 11, with a target compliance value (shown by the dots) and deviation from their compliance (shown by relative placement of the dot in the respective box). The area above the dot in each box represents a relative amount of offerings that meet the policy (i.e., compliant), while the area below represents a relative amount of offerings that fail to meet the policy (i.e., non-compliant). For example, it can be seen that for resource R5, most of the offerings are compliant but for resource R2, most offerings are non-compliant.

The chart on the lower right shows a compliance parameter breakdown 58 for the top resources. In this example, there are three compliance parameters that are evaluated (C1, C2, C3). Compliance parameters may for example include: support (i.e., is adequate support provided by provider nodes 17), pricing (i.e., is the resource priced according to the policy), and branding (i.e., is the resource branded correctly with the correct logos, etc.). Accordingly, a user can quickly ascertain which resources have the most compliance issues, and which compliance parameters are most often not met. Obviously, more, fewer or other compliance parameter can be evaluated and shown.

It is understood that the illustrative dashboard 50 of FIG. 4 provides a few possible views into compliance data of the network 11. Other views may for example allow the user to drill down to view granular data of individual provider nodes, individual resources, and/or individual channels. The dashboard 50 thus allows a viewer to quickly identify areas of the network 11 that have the greatest compliance issues. Based on this information, remedial action can be taken in a much more strategic manner, in addition to any ad hoc approaches being taken. For example, based on the bubble graph, it is evident that CH 2 has a large amount compliance issues for a relatively small number of offerings. The enterprise may determine that trying to correct the compliance issues and continuing to provision resources into this channel is not worth the effort. Rather, efforts are better spent focusing on the other channels.

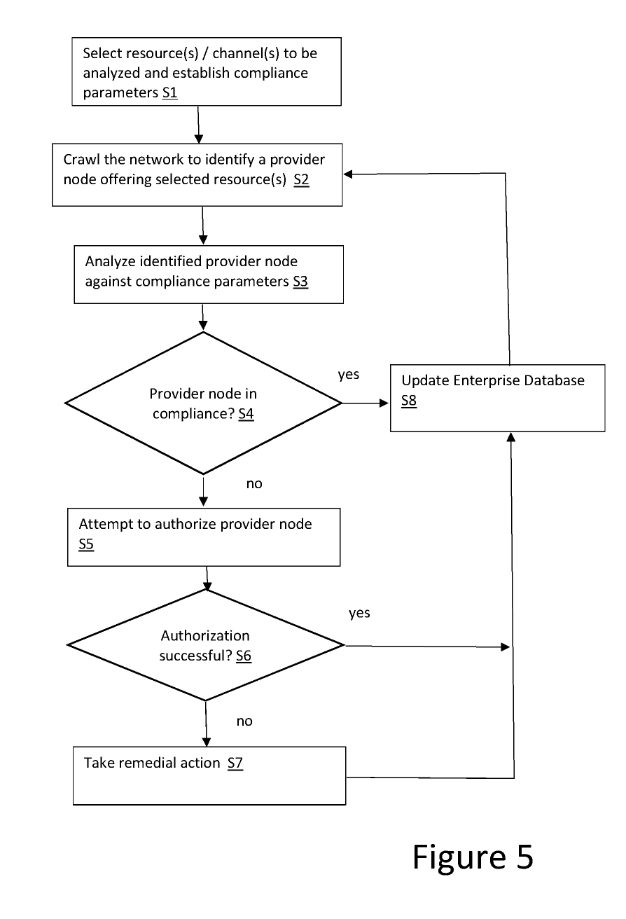

FIG. 5 depicts a flow diagram of an illustrative network compliance process. At S1, one or more proprietary resources and channels 25 are selected and compliance parameters are established. At S2, the selected channel(s) within the network is crawled with an agent until a provider node 17 offering one of the proprietary resources is identified and at S3, the identified provider node 17 is analyzed against the compliance parameters. At S4, a determination is made whether the provider node 17 is in compliance. As noted, compliance can be determined in any manner. For example, in the case where three parameters are evaluated, each of the three evaluations may require a passing score for compliance to be achieved. In other cases, a weighted average of the individual evaluations f may be calculated to arrive a score that is compared against a threshold value to determine compliance. E.g.,

Score=f(W₁*C1)+f(W₂*C2)+f(W₃*C3)

Where C1, C2, C3 are compliance parameters and W₁, W₂, W₃ are predefined weights. If Score>threshold, then node is in compliance.

If yes S4, the enterprise database 38 is updated and the agent crawls the network until a next provider node 17 offering one of the proprietary resources is identified at S2. If no at S4, then an attempt is made to authorize the non-compliant provider node 17 at S5. If the authorization is successful at S6, then the enterprise database 38 is updated and the agent crawls the network until a next provider node 17 offering one of the proprietary resources is identified at S2. If the authorization is not successful at S6, then remedial action is taken at S7, the enterprise database 38 is updated and the agent crawls the network until a next provider node 17 offering one of the proprietary resources is identified at S2. Once all the nodes in the selected channel(s) have be crawled, the process stops, and the dashboard 50 is updated.

The compliance and visualization platform 18 (FIG. 2) may be applied to any hierarchical network or graph. For example, in an autonomous car-sharing service, the enterprise node 13 may comprise a cloud service that provisions instructions and updates to channels such as Uber and Lyft vehicles, e.g., an AI based routing service, entertainment services, security updates, etc. Compliance analysis may be run to ensure that, e.g., the based routing service is properly installed. In an online marketplace, the enterprise node 13 may comprise a supplier of branded merchandise that distributes goods through computerized channels such as Amazon, eBay, etc. In this case, distributors (i.e., broker nodes) engage resellers (i.e., provider nodes) having a web storefront to offer the branded merchandise. In this case, the compliance analysis may ensure that the resellers are pricing merchandise correctly. As noted, proprietary resources may comprise any process, service, product, item, code, agent, etc., that has some proprietary relationship with an enterprise node 13, e.g., copyrighted software, computer hardware resources, a resource with a unique ID or model, a branded product or service, or any other resource having some type of source identifying function.

It is understood that platform 18 (FIG. 2) may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a block-chain set of networked devices or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 20, an input/output (I/O) 14 (e.g., one or more I/O interfaces and/or devices), and a communications pathway 16. In general, processor(s) 12 execute program code which is at least partially fixed in memory 20. While executing program code, processor(s) 12 can process data, which can result in reading and/or writing transformed data from/to memory and/or I/O 14 for further processing. The pathway 16 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that platform 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A platform for managing and visualizing compliance of nodes in a hierarchical network (“network”), comprising:
a system for interfacing with the network, wherein the network includes an enterprise node that provisions a proprietary resource to a set of broker nodes and a set of provider nodes;
a monitoring system that deploys agents to crawl the network to identify and analyze provider nodes that offer the proprietary resource to determine a compliance of each provider node in accordance with a policy;
a registration system for authorizing provider nodes within the network;
an enterprise database that stores compliance data and authorization data for provider nodes in the network; and
a visualization system for visualizing compliance data regarding the provider nodes.

2. The platform of claim 1, wherein compliance is determined by analyzing the participating provider node against a set of defined compliance parameters.

3. The platform of claim 1, wherein the enterprise node comprises a server and the provider nodes comprise clients.

4. The platform of claim 1, wherein the provider nodes comprise one of websites, cloud service providers or electronic storefronts.

5. The platform of claim 1, wherein compliance is determined by comparing details collected from a provider node to a set of predefined compliance parameters.

6. The platform of claim 1, further comprising an analysis system for analyzing a knowledgebase of data from a set of enterprise nodes to predict compliance among different channels, broker nodes, or resource categories.

7. The platform of claim 1, wherein the visualization system shows compliance throughout the network on a channel level and a resource level.

8. A computer program product stored on a non-transitory computer medium, which when executed by a computing systems, provides a platform for managing and visualizing compliance of nodes in a network, the program product comprising:
program code for interfacing with the network, wherein the network includes an enterprise node that provisions a proprietary resource to a set of broker nodes and a set of provider nodes;
program code that deploys agents to crawl the network to identify and analyze provider nodes that offer the proprietary resource to determine a compliance of each provider node in accordance with a policy;
program code for authorizing provider nodes within the network;
program code that stores compliance data and authorization data for provider nodes in the network; and
program code for visualizing compliance data regarding the provider nodes.

9. The program product of claim 8, wherein compliance is determined by analyzing the participating provider node against a set of defined compliance parameters.

10. The program product of claim 8, wherein the enterprise node comprises a server and the provider nodes comprise clients.

11. The program product of claim 8, wherein the provider nodes comprise one of websites, cloud service providers or electronic storefronts.

12. The program product of claim 8, wherein compliance is determined by comparing details collected from a provider node to a set of predefined compliance parameters.

13. The program product of claim 8, further comprising program code for analyzing a knowledgebase of data from a set of enterprise nodes to predict compliance among different channels, broker nodes, or resource categories.

14. The program product of claim 8, wherein a visualization shows compliance throughout the network on a channel level and a resource level.

15. A computerized method for managing and visualizing compliance of nodes in a network, the method comprising:
providing an interfacing with the network, wherein the network includes an enterprise node that provisions a proprietary resource to a set of broker nodes and a set of provider nodes;
deploying agents to crawl the network to identify and analyze provider nodes that offer the proprietary resource to determine a compliance of each provider node in accordance with a policy;
authorizing provider nodes within the network;
storing compliance data and authorization data for provider nodes in the network; and
visualizing compliance data regarding the provider nodes.

16. The method of claim 15, wherein compliance is determined by analyzing the participating provider node against a set of defined compliance parameters.

17. The method of claim 15, wherein the provider nodes comprise one of websites, cloud service providers or electronic storefronts.

18. The method of claim 15, wherein compliance is determined by comparing details collected from a provider node to a set of predefined compliance parameters.

19. The method of claim 15, further comprising analyzing a knowledgebase of data from a set of enterprise nodes to predict compliance among different channels, broker nodes, or resource categories.

20. The method of claim 15, wherein a visualization shows compliance throughout the network on a channel level and a resource level.
